(19) United States
(12) Patent Application Publication
(10) Pub. No.: US 2019/0087764 A1
(43) Pub. Date: Mar. 21, 2019

(54) SYSTEM AND METHOD FOR ASSESSING PUBLISHER QUALITY

(71) Applicant: Cognant LLC, Mountain View, CA (US)

(72) Inventors: Bhargav Bhushanam, Mountain View, CA (US); Heng Wang, San Jose, CA (US); Daniel Gelman, Palo Alto, CA (US); Arun Kejariwal, Fremont, CA (US); James Koh, Mountain View, CA (US); Vivek Girotra, San Francisco, CA (US); Brian Walker, Union City, CA (US); Marcel Sanchez, Mountain View, CA (US)

(21) Appl. No.: 16/059,391

(22) Filed: Aug. 9, 2018

Related U.S. Application Data
(60) Provisional application No. 62/560,858, filed on Sep. 20, 2017.

(51) Int. Cl. G06Q 10/06; H04L 29/06; H04L 29/08; G06F 17/30

(52) U.S. Cl. CPC G06Q 10/06393; H04L 63/1425; G06F 17/30958; H04L 67/22; H04L 63/1416

(57) ABSTRACT

A method, a system, and an article are provided for assessing and managing the presentation of digital content by a group of publishers. An example computer-implemented method can include: obtaining data including a history of (i) content presentations by a plurality of publishers on a plurality of client devices and (ii) user activity associated with the content presentations on the client devices; determining a touch point journey for each of a plurality of conversion events; calculating one or more first performance indicators for each publisher based on the touch point journeys; calculating one or more second performance indicators for each publisher based on the history of user activity associated with the content presentations; calculating a publisher quality score for each publisher based on the first and second performance indicators; and, based on the calculated scores, facilitating an adjustment of content presentations by the plurality of publishers.

### CROSS-REFERENCE TO RELATED APPLICATIONS

This application claims the benefit of U.S. Provisional Patent Application No. 62/560,858, filed Sep. 20, 2017, the entire contents of which are incorporated by reference herein.

### BACKGROUND

The present disclosure relates generally to the presentation of digital content by publishers and, in certain examples, to systems and methods for detecting and managing anomalous publisher activity associated with the digital content presentations.

In general, client devices are capable of presenting a wide variety of content, including images, video, audio, and combinations thereof. Such content can be stored locally on client devices and/or can be sent to the client devices from server computers over a network (e.g., the Internet). To watch an online movie, for example, a user of a client device can download a copy of the movie and/or can stream the movie from a content provider. Online content can be provided to client devices by publishers, such as websites and software applications.

Users can interact with content in various ways. A user can, for example, view images, listen to music, or play computer games. With certain online content, a user can select the content or a portion thereof and be directed to a website where further content can be presented or obtained. In some instances, users can download or receive content in the form of software applications.

### SUMMARY

In general, the subject matter of this disclosure relates to assessing and managing the presentation of digital content (e.g., images, videos, audio, text, online games, and any combination thereof) by a group of publishers (e.g., websites or software applications). In various instances, the publishers can be used to present content on client devices. Data related to the content presentations can be collected and used to calculate key performance indicators (KPIs) for each publisher. The KPIs can be analyzed (e.g., using an isolation forest model) to determine an ability of each publisher to (i) reach a unique set of users and/or (ii) achieve certain desired user interaction with the content. Additionally or alternatively, the KPIs can be analyzed to detect certain fraudulent publisher activity. One or more scores can be calculated, based on the KPIs, that provide an indication of publisher quality, and the scores can be used to adjust future content presentations by the publishers. For example, high quality publishers can be given additional content to present, while low quality publishers can be given little or no additional content to present.

Advantageously, the anomaly detection systems and methods described herein can leverage novel algorithms and/or big data platforms to extract actionable insights and help content users, buyers, publishers, or distributors take action in the event of unexpected or anomalous publisher behavior. The algorithmic-based approach described herein is particularly important and valuable, given the evolving nature of publisher activity and a consequent need for publisher quality assessments to be auto-adaptive. More particularly, the approach described herein is directed to an anomaly detection architecture that can make use of dynamic and robust anomaly detection algorithms. The approach can provide a modular and extensible framework that can make use of batch processing to surface abnormal deviations of performance related metrics in a timely and accurate manner. In general, the approach represents a substantial improvement in the ability of a computer to detect anomalies related to publisher activity and to assess publisher quality.

In one aspect, the subject matter described in this specification relates to a computer-implemented method. The method includes: obtaining data including a history of (i) content presentations by a plurality of publishers on a plurality of client devices and (ii) user activity associated with the content presentations on the client devices; identifying a plurality of conversion events associated with the content presentations; determining a touch point journey for each conversion event, the touch point journey including a sequence of one or more of content presentations associated with the conversion event; calculating one or more first performance indicators for each publisher based on the touch point journeys; calculating one or more second performance indicators for each publisher based on the history of user activity associated with the content presentations; calculating a score for each publisher based on the one or more first performance indicators and the one or more second performance indicators, the score providing or including an indication of publisher quality; and based on the calculated scores, facilitating an adjustment of content presentations by the plurality of publishers.

In certain examples, the user activity can include action taken by users during and/or after the content presentations. The action taken by users after the content presentations can include installing a software application and interacting with the software application. At least one of the conversion events can be or include action encouraged by one or more of the content presentations. Determining the touch point journey can include generating a directed graph in which nodes represent the publishers and edges represent interaction between publishers.

In some instances, the one or more first performance indicators for a publisher can include a measure of interaction between the publisher and other publishers. The one or more second performance indicators for a publisher can include a measure of user activity associated with content presented by the publisher. The score can be calculated using an isolation forest model. Calculating the score can include: calculating a first score including an indication of anomalous publisher performance; and calculating a second score including an indication of a favorability of the anomalous publisher performance. Facilitating the adjustment of content presentations can include preventing a publisher from presenting content.

In another aspect, the subject matter described in this specification relates to a system having one or more computer processors programmed to perform operations including: obtaining data including a history of (i) content presentations by a plurality of publishers on a plurality of client devices and (ii) user activity associated with the content presentations on the client devices; identifying a plurality of conversion events associated with the content presentations; determining a touch point journey for each conversion event, the touch point journey including a sequence of one or more of content presentations associated with the conversion event; calculating one or more first performance indicators for each publisher based on the touch point journeys; calculating one or more second performance indicators for each publisher based on the history of user activity associated with the content presentations; calculating a score for each publisher based on the one or more first performance indicators and the one or more second performance indicators, the score providing or including an indication of publisher quality; and based on the calculated scores, facilitating an adjustment of content presentations by the plurality of publishers.

In various examples, the user activity can include action taken by users during and/or after the content presentations. The action taken by users after the content presentations can include installing a software application and interacting with the software application. At least one of the conversion events can be or include action encouraged by one or more of the content presentations. Determining the touch point journey can include generating a directed graph in which nodes represent the publishers and edges represent interaction between publishers.

In certain implementations, the one or more first performance indicators for a publisher can include a measure of interaction between the publisher and other publishers. The one or more second performance indicators for a publisher can include a measure of user activity associated with content presented by the publisher. The score can be calculated using an isolation forest model. Calculating the score can include: calculating a first score including an indication of anomalous publisher performance; and calculating a second score including an indication of a favorability of the anomalous publisher performance. Facilitating the adjustment of content presentations can include preventing a publisher from presenting content.

In another aspect, the subject matter described in this specification relates to an article. The article includes a non-transitory computer-readable medium having instructions stored thereon that, when executed by one or more computer processors, cause the computer processors to perform operations including: obtaining data including a history of (i) content presentations by a plurality of publishers on a plurality of client devices and (ii) user activity associated with the content presentations on the client devices; identifying a plurality of conversion events associated with the content presentations; determining a touch point journey for each conversion event, the touch point journey including a sequence of one or more of content presentations associated with the conversion event; calculating one or more first performance indicators for each publisher based on the touch point journeys; calculating one or more second performance indicators for each publisher based on the history of user activity associated with the content presentations; calculating a score for each publisher based on the one or more first performance indicators and the one or more second performance indicators, the score providing or including an indication of publisher quality; and based on the calculated scores, facilitating an adjustment of content presentations by the plurality of publishers.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for assessing and managing the presentation of digital content by a group of publishers.

FIG. 2 is a schematic data flow diagram of an example system for assessing and managing the presentation of digital content by a group of publishers.

FIG. 3 is a directed graph representing interactions among a group of publishers, in accordance with certain examples of this disclosure.

FIG. 4 is a scatter plot of a first performance indicator versus a second performance indicator, for a group of publishers, in accordance with certain examples of this disclosure.

FIG. 5 is a flowchart of an example method of assessing and managing the presentation of digital content by a group of publishers.

### DETAILED DESCRIPTION

In general, the subject matter of this disclosure relates to evaluating the quality of publishers (e.g., websites and/or software applications) of digital content on client devices. Users of the client devices can interact with the content and can take certain action (e.g., install and/or use a software application) in response to the content. When such user action is attributed to a specific publisher, the publisher can receive compensation. This can incentivize publishers to engage in fraudulent activity in an effort to obtain the attribution and compensation. Such fraudulent publishers can be considered to be low quality. Additionally or alternatively, publisher quality can refer to an ability of a publisher to reach a unique set of users and/or to achieve certain desired user activity. For example, publishers that reach unique users and/or achieve desired user activity can be considered to be higher quality. Publishers that reach a non-unique set of users (e.g., users who are also reached by other publishers) and/or are unable to achieve desired user activity can be considered to be lower quality.

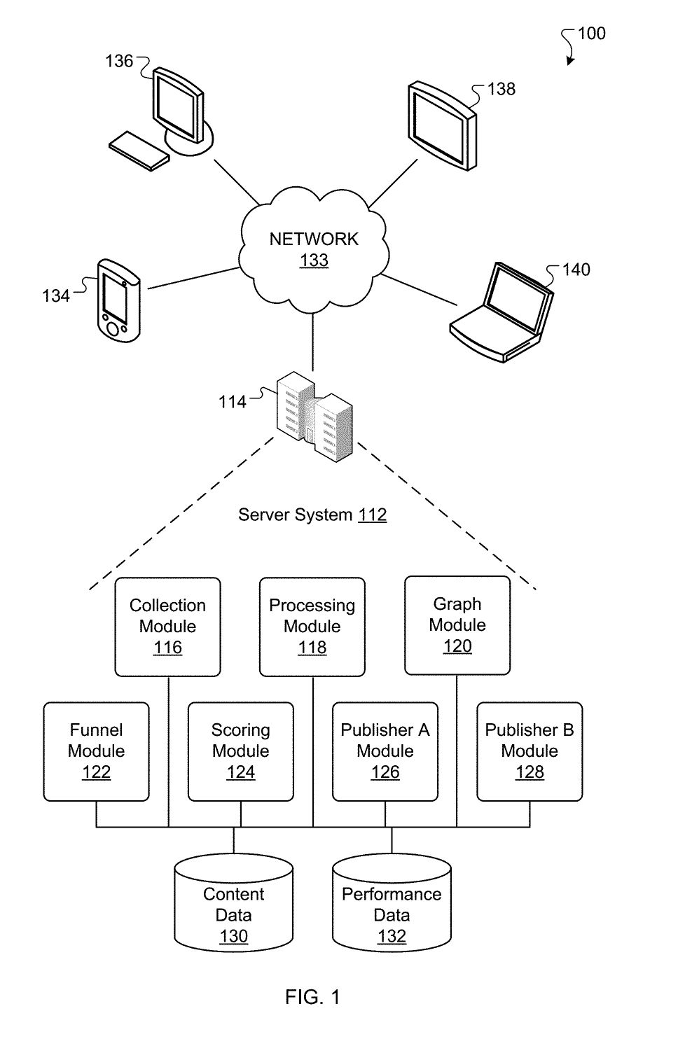

FIG. 1 illustrates an example system 100 for evaluating publisher quality. A server system 112 provides functionality for collecting and processing data streams associated with digital content. The server system 112 includes software components and databases that can be deployed at one or more data centers 114 in one or more geographic locations, for example. In certain instances, the server system 112 is, includes, or utilizes a content delivery network (CDN). The server system 112 software components can include a collection module 116, a processing module 118, a graph module 120, a funnel module 122, a scoring module 124, a publisher A module 126, and a publisher B module 128. The software components can include subcomponents that can execute on the same or on different individual data processing apparatus. The server system 112 databases can include a content data 130 database and a performance data 132 database. The databases can reside in one or more physical storage systems. The software components and data will be further described below.

An application, such as, for example, a web-based application, can be provided as an end-user application to allow users to interact with the server system 112. The client application or components thereof can be accessed through a network 133 (e.g., the Internet) by users of client devices, such as a smart phone 134, a personal computer 136, a tablet computer 138, and a laptop computer 140. Other client devices are possible. In alternative examples, the content data 130 database, the performance data 132 database, or any portions thereof can be stored on one or more client devices. Additionally or alternatively, software components for the system 100 (e.g., the collection module 116, the processing module 118, the graph module 120, the funnel module 122, the scoring module 124, the publisher A module 126, and the publisher B module 128) or any portions thereof can reside on or be used to perform operations on one or more client devices.

FIG. 1 depicts the collection module 116, the processing module 118, the graph module 120, the funnel module 122, the scoring module 124, the publisher A module 126, and the publisher B module 128 as being able to communicate with the content data 130 database and the performance data 132 database. The content data 130 database generally includes digital content that can be presented on the client devices. The digital content can be or include, for example, images, videos, audio, computer games, text, messages, offers, and any combination thereof. The performance data 132 database generally includes information related to the presentation of digital content on the client devices and any interactions with the digital content by users of the client devices. Such information can include, for example, a history of user interactions with the digital content, including a record of the types of user interactions (e.g., viewing, selecting, clicking, playing, installing, etc.) and the times at which such user interactions occurred (e.g., time and date).

In general, digital content (e.g., from the content data 130 database) can be presented on the client devices using a plurality of publishers, which can include the publisher A module 126 and the publisher B module 128. Any suitable number of publishers and publisher modules are possible. Each publisher can be or include, for example, a website and/or a software application configured to present the content. When an item of content is presented on a client device, the user can interact with the content in multiple ways. For example, the user can view the content, select or click one or more portions of the content, play a game associated with the content, and/or take an action associated with the content. In certain instances, the action can be or include, for example, watching a video, viewing one or more images, selecting an item (e.g., a link) in the content, playing a game, visiting a website, downloading additional content (e.g., a software application), and/or installing or using a software application. In some instances, the content can offer the user a reward in exchange for taking the action. The reward can be or include, for example, a credit to an account, a virtual item or object for an online computer game, free content, or a free software application. Other types of rewards are possible.

Additionally or alternatively, in some instances, the publishers can be rewarded based on actions taken by users in response to the presented content. For example, when a user clicks or selects an item of content or takes a certain action in response to the content, the publisher can receive a reward or compensation from an entity (e.g., a person or a company) associated with the content or the action. The reward or compensation can provide an incentive for the publisher to display the content.

In some instances, for example, a publisher can receive compensation when it presents an item of content on a client device and a user installs a software application (or takes a different action) in response to the content. The publisher can provide information to the collection module 116 indicating that the content was presented on the client device. Alternatively or additionally, the collection module 116 can receive an indication that the user selected the content and/or that the software application was installed. Based on the received information, the collection module 116 can attribute the software application installation to the item of content presented by the publisher. The publisher can receive the compensation based on this attribution.

In various examples, the collection module 116 can be or include an attribution service provider. The attribution service provider can receive information from publishers related to the presentation of content and user actions in response to the content. The attribution service provider can determine, based on the information received, how to attribute the user actions to individual publishers. In some instances, for example, a user can visit or use websites or software applications provided by publishers that present an item of content at different times on the user's client device. When the user takes an action (e.g., installs a software application) in response to the content presentations, the attribution service provider may select one of the publishers to receive the credit or attribution for the action. The selected publisher may be, for example, the publisher that was last to present content or to receive a click on content before the user took the action. The selected publisher can receive compensation from an entity associated with the content or the action. Other publishers that presented content and or received clicks on content may receive no such compensation.

This scheme in which publishers can receive compensation based on attribution for user actions can result in fraudulent publisher activity. For example, a fraudulent publisher can send incorrect or misleading information to the collection module 116 (or attribution server provider) in an effort to fool the collection module 116 into attributing user action to content presented by the publisher. The fraudulent publisher can, for example, provide information to the collection module 116 indicating that the content was displayed on the user's client device when the content was not in fact displayed. Additionally or alternatively, the fraudulent publisher can provide information to the collection module 116 indicating that the user interacted with the content (e.g., clicked on the content) when such interactions did not occur. Based on this incorrect information, the collection module 116 (or attribution service provider) can erroneously attribute user action (e.g., a software application installation) to the fraudulent publisher, which may be rewarded (e.g., with money) for its deceitful activity. Various other types of publisher fraud can result in erroneous attributions, including, for example, click fraud, impression fraud, cookie stuffing fraud, user engagement fraud, ad injection fraud, ad laundering fraud, fraud through install farms, and the like. Descriptions of these forms of fraud are provided in Table 1.

TABLE 1
Types of publisher fraud.

| Fraud Type | Description |
|---|---|
| Click Fraud | A form of fraudulent activity in which a publisher or |
| | other component or entity generates fake or phony |
| | clicks on one or more client devices, and/or provides |
| | an indication that such fake or phony clicks have |
| | occurred on the one or more client devices. |
| Impression Fraud | A form of fraudulent activity in which a publisher or |
| | other component or entity falsely reports impressions |
| | by practices such as reporting hidden impressions or |
| | falsely reporting an impression as a click, which can |
| | lead to fictitiously high conversion rates. |
| Cookie Stuffing | A form of fraudulent activity where multiple cookies |
| Fraud | are dropped on a user's web browser after the user |
| | views a page or clicks on a link. This can lead to |
| | one publisher stealing credit from a legitimate |
| | publisher and hence wrongful attribution. |
| User Engagement | A form of fraudulent activity in which a publisher or |
| Fraud | other entity can provide phony or fake evidence of |
| | positive user engagement with a software |
| | application. This can lead to wrongful budget |
| | allocations. |
| Click Injection | A form of fraudulent activity in which a publisher or |
| Fraud | other entity can claim credit for an install by |
| | injecting a click right before a user opens the |
| | software application. This can lead to blatant |
| | stealing of credit for the install. |
| Ad Laundering | A form of fraudulent activity in which an actual |
| Fraud | URL for an item of content is concealed with other |
| | URLs or sites that pose as legitimate publishers. |
| Install Farm | Install farms are collections of real mobile devices |
| Fraud | used to perpetrate app installs and engagement fraud. |
| | The fraudulent activity generally involves clicking |
| | on mobile ads, installing apps, and engaging for a |
| | limited time. |

In various examples, the system 100 can determine publisher quality and/or detect fraudulent publisher activity by calculating and analyzing various key performance indicators (KPIs) related to publishers and publisher content presentations. The KPIs can be calculated based on information received from publishers by the collection module 116. The KPIs can be or include, for example, a number of content presentations (also referred to as impressions), a number of content selections (also referred to as clicks), a number of engagements with a software application, a number of software application installs, a number of conversions (e.g., purchases or offer acceptances), and/or any combination thereof. Other KPIs are possible. For example, certain derived metrics can be used as KPIs for a game application. Such KPIs can include, for example, a rate of player advancement in a game, a percentage of users who change or drop one or more levels in the game, and/or a percentage of users who make purchases in the game. In some instances, a ratio, product, sum, or difference of two or more KPIs can be informative, such as a ratio of the number of clicks to the number of content presentations (referred to as click-through rate), or the ratio of the number of clicks to the number of installs (referred to as click-to-install ratio). Each KPI is typically calculated for a period of time, such as a previous hour, day, or week. The KPIs can be updated or recalculated as additional information is collected over time.

In a typical instance, publisher quality can be evaluated and/or publisher fraudulent activity can be identified by detecting anomalies in one or more KPIs. Such anomalies can be caused by a wide variety of factors. For example, when a frequency at which an item of content is presented increases, a corresponding increase in KPIs related to content presentations and/or content clicks can occur. Additionally or alternatively, when a publisher attempts to drive a high number of clicks through fraudulent means (e.g., bots) in an effort to win attributions illegitimately, such efforts can show up as spikes in click volume. In some instances, when an appealing new item of content is presented, a large number of users can interact with the content or take action (e.g., installing an application) based on the content. In another example, data losses can prevent the collection module 116 from receiving certain portions of publisher data, which can result in KPI anomalies.

Anomalous publisher quality can be caused by other factors, including low-intent user acquisition and/or technical integration issues. In some cases, for example, a group of users associated with a publisher may not be relevant to the content being presented or the action being encouraged by the content. This can lead to anomalous publisher quality in the form of low conversion rates, low engagement metrics (e.g., little or no user interaction with content), and/or high churn rate (e.g., little or no user activity following a conversion event). Additionally or alternatively, technical integration issues can result in anomalous publisher quality by, for example, failing to provide a redirect when a user selects an item of content, improperly tracking or counting user inputs, or erroneously counting content presentations as user interactions with content.

In some instances, the quality of a publisher can be assessed by determining an incremental effect of the publisher. In certain instances, for example, content developers and/or providers can utilize many different publishers to present similar or identical items of content on client devices. This can result in multiple touch points in which a user is presented with a sequence of identical or similar items of content from multiple publishers before any conversion event occurs (e.g., before the user takes an action encouraged by the content). The multiple touch points can lead to attribution competition, publisher fraud, and/or high inefficiencies in content presentations and associated costs. By measuring a removal effect of a publisher, the system 100 can calculate an important set of KPIs for assessing publisher quality. In certain instances, removal effect can provide an indication of the incremental effect of the publisher on conversion events. For example, removal effect can be used to predict or determine how conversion events would change if the publisher had not been used or were no longer used to present content. Such changes could involve or include, for example, a loss of one or more conversion events, or a conversion event being attributed to a different publisher or to no publisher (e.g., an organic user event). In general, a conversion event can occur when a user takes a specific action (e.g., installing a software application or playing an online game) in response to an item of content that encourages the user to take the action.

In certain instances, the removal effect of a publisher or node in a publisher network can be calculated by (i) considering a hypothetical scenario in which the node does not exist and (ii) determining which remaining node, if any, would receive attribution (e.g., for an install or other conversion event). This can result in a situation where a certain portion of conversions that were earlier attributed to the node can no longer be attributed to any node and hence may be attributed as organic. A high portion of such installs for a node can mean that the removal effect of the node is high and/or that the publisher plays a significant role in achieving conversions. In general, nodes with high removal effect can be considered to be high quality nodes and/or can be treated as good sources of quality.

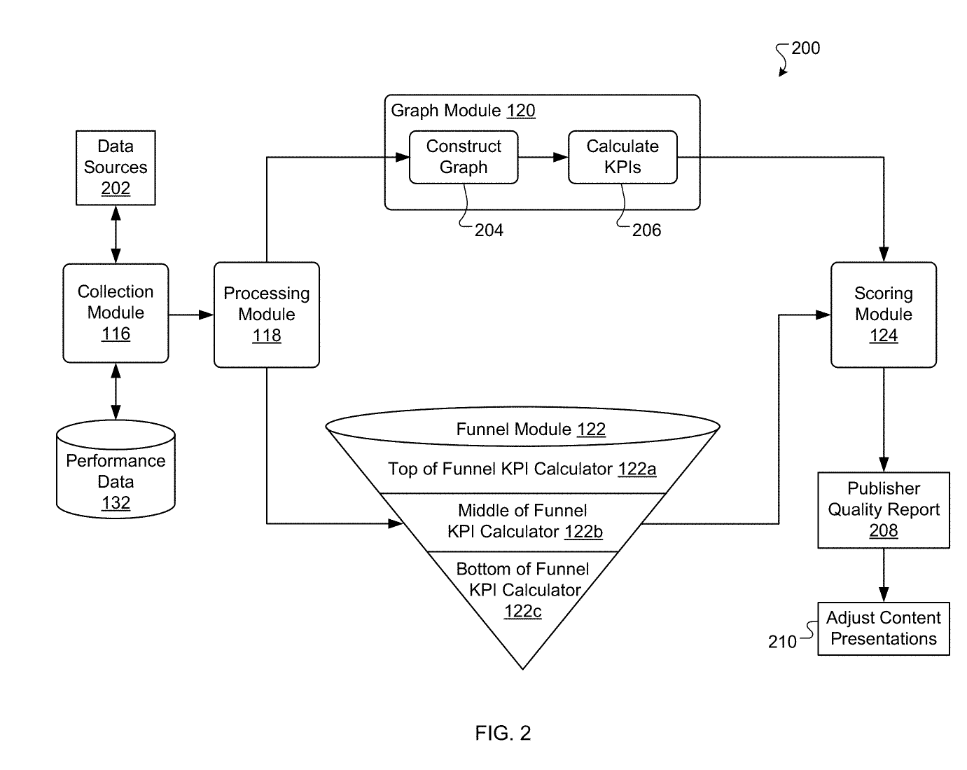

Referring to FIG. 2, in various examples, a system 200 for determining publisher quality includes the collection module 116, the processing module 118, the graph module 120, the funnel module 122, and the scoring module 124. The collection module 116 can receive source data from one or more data sources 202. The source data can be or include, for example, a stream of data including a record of content presentations on client devices and/or user activity (e.g., clicks, software installs, or subsequent activity) associated with the content presentations. The stream of data can be a live data stream, such that data for a content presentation or user activity can be received immediately or shortly (e.g., within seconds or minutes) after the presentation or user activity occurs. The data sources 202 can be or include, for example, one or more publishers, such as the publisher A module 126 and the publisher B module 128, and/or one or more client devices. The source data can be stored in the performance data 132 database.

The source data can be provided from the collection module 116 or the performance data 132 database to the processing module 118. The processing module 118 can cleanse the source data to remove any erroneous data or handle any missing or inaccurate data. Additionally or alternatively, the processing module 118 can determine or create touch point journeys for conversion events. A touch point journey can be or include, for example, a sequence of content presentations that led to a conversion event. To create the touch point journeys, the processing module 118 can join content presentation data (e.g., data indicating content was presented to a user) and/or click data (e.g., data indicating a user clicked or selected content) to conversion event data (e.g., data indicating a user installed software or took other action encouraged by content) on various waterfall levels (e.g., device id, fingerprint, IP address, etc.), preferably in decreasing order of attribution waterfall priority. In various examples, a device id click/impression can have a higher attribution waterfall priority than a fingerprint click/impression, followed by a click/impression that contains only IP address, for example, without any device id or user agent information. Each individual content presentation and/or click on content can represent a touch point in a complete journey to conversion of a user. Additionally or alternatively, the source data can be aggregated by publisher, so that each publisher can be more readily assessed.

In certain examples, the system 200 can assign a quality score to each publisher by calculating and analyzing various KPIs. A portion of the KPIs can be calculated using the graph module 120 and another portion of the KPIs can be calculated using the funnel module 122.

In general, the graph module 120 receives touch point journey data from the processing module 118 and constructs a directed graph (step 204) in which nodes represent publishers and edges (also referred to herein as arrows) represent interactions between the publishers. For example, Table 2 presents touch point journey data for an example scenario in which items of content were presented by six publishers (A to F) to seven different users (1 to 7), before each user completed a conversion event. The touch point journey for user 1, for example, includes presentations of content by the following sequence of publishers: A→B→C→D. Likewise, the touch point journey for user 2 includes presentations of content by the following sequence of publishers: C→A→E. The touch point journey for user 4 includes a content presentation only by publisher F.

TABLE 2
Touch point journey data for an example involving
publishers A-F and users 1-7.

| | 1st | 2nd | 3rd | 4th |
|---|---|---|---|---|
| User | Content | Content | Content | Content |
| 1 | A | B | C | D |
| 2 | C | A | E | |
| 3 | B | D | | |
| 4 | F | | | |
| 5 | C | A | B | |
| 6 | D | C | B | |
| 7 | C | D | | |

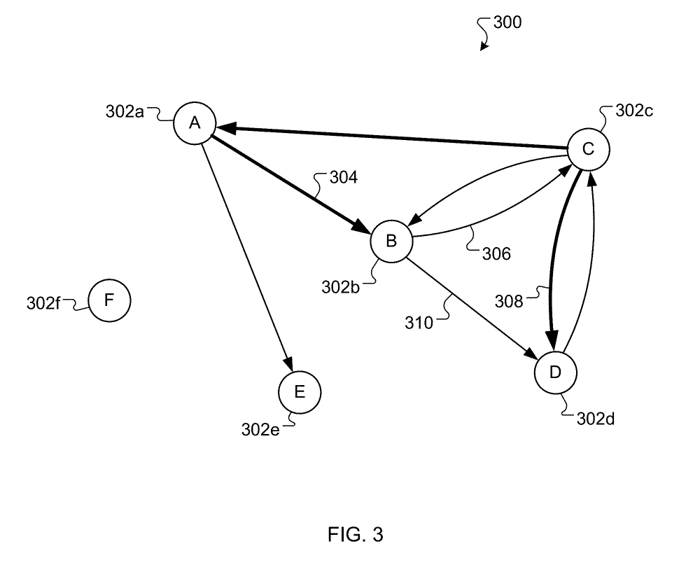

FIG. 3 includes a directed graph 300 derived from the touch point journey data in Table 2. Each circle or node in the graph 300 represents one of the publishers, and each arrow in the graph indicates that one publisher presented content to a user before another publisher presented content to the user. For example, nodes 302a, 302b, 302c, 302d, 302e, and 302f represent publishers A (e.g., the publisher A module 126), B (e.g., the publisher B module 128), C, D, E, and F, respectively. The touch point journey for user 1 is represented by an arrow 304 from node 302a to node 302b, an arrow 306 from node 302b to node 302c, and an arrow 308 from node 302c to node 302d. The touch point journeys for other users are represented with similar arrows or combinations of arrows. For example, the touch point journey for user 3 is represented by an arrow 310 from node B to node D. The touch point journey for user 4 is represented by only node 302f, given that only publisher F presented content to user 4 before the conversion event occurred. In general, each item of content presented by publishers in a touch point journey can encourage identical or similar user activity. The touch point journey can end when the desired or encouraged user activity occurs.

In the depicted example, certain arrows are drawn with thicker lines to indicate more than one connection between a pair of nodes. For example, the arrow 304 from node A to node B is represented with a thicker line because it forms part of the touch point journey for both user 1 and user 5. Other ways of representing multiple connections between two nodes can be used, such as color coding or numerical labels. In general, however, the graph module 120 can determine and track a number of times an item of content was presented by one publisher (e.g., publisher A) before the item of content (or similar item of content) was presented by another publisher (e.g., publisher B). In this way, the graph module 120 can determine the number of times one publisher influenced or played a role in conversions achieved by or attributed to another publisher. While the graph module 120 preferably generates and uses directed graphs (e.g., directed graph 300) to make such determinations, the graph module 120 can alternatively make such determinations without generating or using a directed graph. For example, the graph module 120 can make such determinations based on touch point journey information stored in a table (e.g., Table 2) or database.

Referring again to FIG. 2, the graph module 120 calculates (step 206) various KPIs based on the touch point journey information and/or the directed graph. The KPIs calculated by the graph module 120 generally provide an indication of relationships or interactions among publishers. For example, some KPIs can provide an indication of a publisher's ability to reach users that are not reached by other publishers. More isolated publishers, such as publisher F, for example, may be able to present content to a unique set of users that does not receive content from other publishers. Likewise, less isolated publishers, such as publisher C, for example, generally tend to present content to users that also receive content from other publishers. In general, isolated publishers that are able to access a unique set of users are more likely to be higher in quality. KPIs calculated by the graph module 120 can include, for example, degree of node, incremental lift of a node, influencing power of one publisher over another, and/or average number of self-influencing clicks per install, as shown in Table 3. Other KPIs can be used. In various examples, the degree of node can be calculated by counting the number of edges that are directed inwards (in-degree) and the number of edges that are directed outwards (out-degree) for each node. The influencing power of one node (e.g., node A) over another node (e.g., node B) can be calculated as the portion of conversions of node B that are influenced by node A. The influencing power KPI can capture a sense or degree of overlap that one publisher has with another publisher.

TABLE 3
Example KPIs generated by graph module 120.

| KPI | Description |
|---|---|
| Degree of node | A number of incoming and/or outgoing edges |
| | for a node/publisher |
| Incremental lift of node | A number of conversions that would be lost |
| | without a publisher |
| Influencing power of | A portion of conversions that one publisher |
| one publisher over | was trying to obtain from another publisher |
| another publisher | |
| Average number of | An average number of clicks per install from |
| self-influencing clicks | the publisher that won the install. This can be |
| per install | captured by a self-loop (self-influencing) on a |
| | particular node. |

Additional KPIs can be calculated by the funnel module 122, which can calculate KPIs for multiple stages of user activity associated with content presentations. For example, a top of funnel KPI calculator 122a can calculate KPIs associated with an initial stage of user interactions with content, such as, for example, content views, content selections or clicks, playable content wins, etc. The initial stage KPIs can be or include, for example, a click through rate, and/or a win ratio. A middle of funnel KPI calculator 122b can calculate KPIs associated with a next or middle stage of user interactions with content, such as interactions that result in or complete conversion events. The middle stage KPIs can be or include, for example, a conversion rate and/or a time to conversion. A bottom of funnel KPI calculator 122c can calculate KPIs associated with a final stage of user interactions with content, such as interactions that occur after conversion events. The final stage KPIs can be or include, for example, a pay rate, a game progression rate, and/or a churn rate. In general, the KPIs calculated by the funnel module 122 can provide an indication of a publisher's ability to present content, generate conversion events, and acquire users who are valuable to content developers and providers (e.g., developers of online games and other applications). Example KPIs calculated by the funnel module 122 are listed in Table 4. Other similar KPIs or combinations thereof can be used.

TABLE 4
Example KPIs generated by graph module 120.

| | Content | |
|---|---|---|
| | Interaction | |
| KPI | Stage | Description |
| Impressions | Initial | A number of content presentations |
| Click through rate | Initial | A fraction of content presentations that are selected |
| | | by users |
| Win ratio | Initial | A portion of games played that are won by users |
| Conversion rate | Middle | A fraction of content presentations that result in a |
| | | conversion event |
| Time to conversion | Middle | An amount of time (e.g., in minutes) between an |
| | | initial content presentation and a corresponding |
| | | conversion event |
| Pay rate | Final | A fraction of users who spend money or make |
| | | purchases in an installed application, such as an |
| | | online game application |
| Game progression | Final | A rate at which users advance in a game |
| rate | | application, such as a multiplayer online game |
| Churn rate | Final | A fraction of users who do not play a game actively |
| | | and/or do not spend money or make purchases in a |
| | | game application, such as a multiplayer online |
| | | game |

Still referring to FIG. 2, the KPIs calculated by the graph module 120 and the funnel module 122 are sent to the scoring module 124, which analyzes the KPIs and generates one or more quality scores for each publisher. In preferred examples, the scoring module 124 can use a publisher anomaly detection methodology, for example, based on an isolation forest model. Parameter tuning for the model can be set to provide a first score S1 having a range of [0,1] for each publisher, where a value of 1 is considered most anomalous and a value of 0 is considered least anomalous. In general, when one or more KPI values for a publisher deviate significantly from corresponding KPI values for other publishers, the publisher can receive a first score S1 that is near or equal to 1.

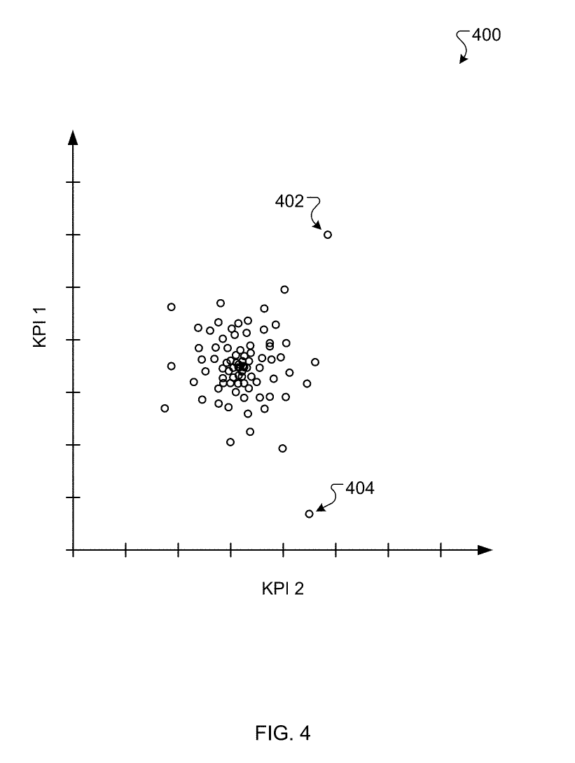

For example, FIG. 4 includes a scatter plot 400 for a simple example involving a first (KPI 1) and a second KPI (KPI 2) for a group of publishers, in which each data point represents one publisher. In the depicted example, the scoring module 124 has identified two anomalies 402 and 404 in the KPI values. To identify these anomalies, the scoring module 124 can determine a distance between each data point and a baseline value (e.g., an average, median, or centroid value) for all the data points. If the distance for a data point exceeds a statistically significant threshold value, the data point and the corresponding publisher can be considered anomalous. For example, when the distance is greater than one, two, or three standard deviations, the difference can be statistically significant. Additionally or alternatively, with the isolation forest model, the detection method can identify anomalies through multivariate analysis (e.g., with all KPIs), for example, in which there is no comparison with a baseline. The isolation forest model can determine how isolated the KPI values are for a publisher by determining a number of partitions required to isolate the KPI values. For example, the model can select a KPI and then randomly partition or split a range of values for the KPI until a data point has been isolated from other data points. The number of partitions required to isolate the data point provides a measure of how anomalous the data point is compared to the other data points. In a typical example, the isolation forest model can construct random decision trees. The first score S1 for a data point can be calculated based on a path length required to isolate the data point. A longer path length can result in a larger first score S1.

Additionally or alternatively, the scoring module 124 can use a second scoring methodology, for example, based on KPI knowledge, domain knowledge, and/or dynamic thresholds for individual KPIs. The second scoring methodology can assign a second score S2, or can modify the first score S1, to indicate whether any publisher anomalies or deviations are favorable or unfavorable (e.g., positively or negatively deviated, respectively). For example, it is generally favorable for the degree of node KPI to be low (e.g., 0 or 1), because such values can indicate that a publisher is able to reach a unique set of users. Likewise, it is generally favorable for the conversion rate KPI to be high (e.g., greater than 50%), because such values can indicate that a publisher is able to achieve a high rate of conversions. In certain examples, the second scoring methodology can capture how many KPIs are positively deviated (e.g., that fall in a top 5th or 10th percentile) for a publisher and how many KPIs are negatively deviated (e.g., that fall in a bottom 5th or 10th percentile) for the publisher. The second score S2 for the publisher can be determined from S2=|G|−|B|, where |G| is a number of positively deviated KPIs and |B| is a number of negatively deviated KPIs.

A final quality score for each publisher can be determined based on the first score S1 and the second score S2 for the publisher. For example, a publisher having a first score S1 near 1 and a negative second score S2 (e.g., −1 or lower) can be considered a low quality publisher. Likewise, a publisher having a first score S1 near 1 and a positive second score S2 (e.g., 1 or higher) can be considered a high quality publisher. Publishers having a first score S1 near 0 can be considered to be of average quality. In some instances, the final score can be based on a product of the first score S1 and the second score S2. When such a final score is positive, the publisher quality can be higher than average. When such a final score is negative, the publisher quality can be lower than average. Table 5 illustrates example combinations of the first and second scores S1 and S2 and corresponding descriptions of publisher quality.

TABLE 5
Example combinations of first and second scores S1 and S2.

| First | Second | Publisher Quality |
|---|---|---|
| Score S1 | Score S2 | Description |
| 1 | ≥1 | High quality |
| 1 | ≤−1 | Low quality |
| 0.5 | ≥1 | Above average |
| 0.5 | ≤−1 | Below average |
| 0 | Any value | Average |

In various examples, the scoring module 124 can utilize suitable machine-learning algorithms or the like to detect anomalies and/or determine publisher quality. In certain instances, for example, the algorithms can use one or more trained classifiers, such as, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests), neural networks, and/or learning vector quantization models. Other classifiers can be used. Once trained, the one or more classifiers can receive KPI data as input and can provide an indication of anomalous publisher activity or publisher quality as output.

Referring again to FIG. 2, the scoring module 124 can generate a publisher quality report 208 that lists or includes the quality scores for the publishers. The publisher quality report 208 can highlight any extreme performing publishers, including both good and bad quality publishers. The extreme performing publishers can be or include, for example, N top and bottom publishers, where N can be any suitable number, such as, for example, 50. The publisher quality report 208 can include a ranked list of values that can be sorted according to any score, KPI, or combination thereof. For example, the publisher quality report 208 can be sorted in two dimensions, according to the first score S1 and the second score S2.

Based on the detected anomalies and/or determined publisher qualities (e.g., in the publisher quality report 208), future content presentations can be adjusted (step 210). For example, when the quality of a publisher is low (e.g., due to fraud), the publisher can be added to a blacklist to prevent the publisher from being able to present content in the future. Alternatively or additionally, when the quality of a publisher is high, the publisher can be given a larger volume of content to present, going forward. The publisher quality report 208 can also be used to request or obtain refunds from any publishers that received compensation based on fraudulent activity. The publisher quality report 208 can be or include an electronic file that is generated or updated on a periodic basis, such as every hour, day, or week. In general, the scoring module 124 and/or users of the system 200 can use the determined publisher qualities to make decisions regarding how and where to present content going forward. Publishers who are identified as performing well (high quality publishers) can be used more in the future, and publishers who are identified as performing poorly or fraudulently (low quality publishers) can be used less in the future or not at all.

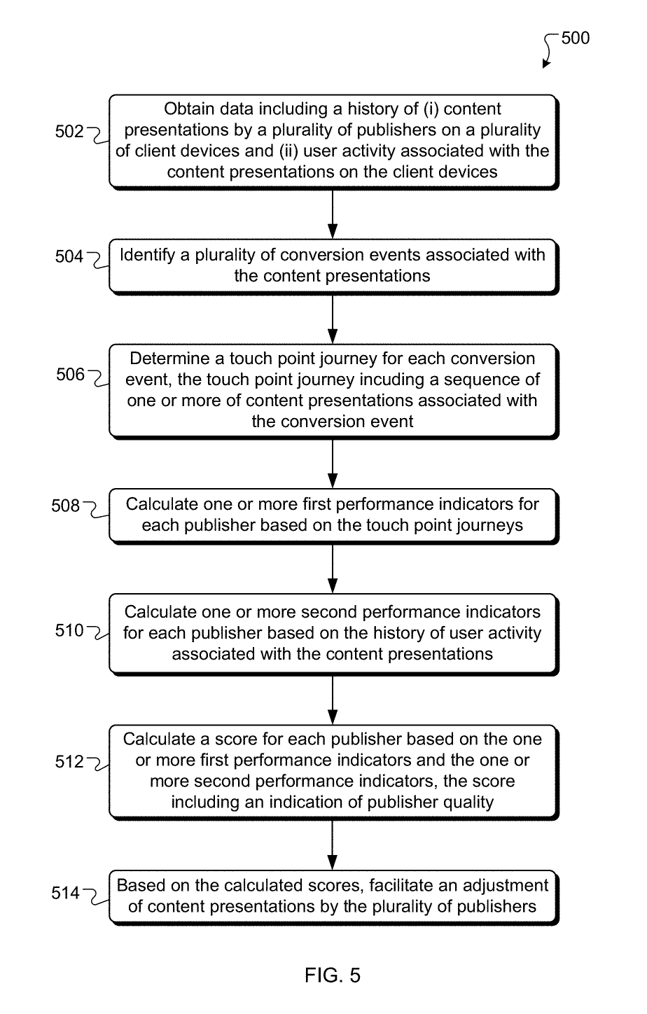

FIG. 5 illustrates an example computer-implemented method 500 of assessing publisher quality. Data is obtained (step 502) that includes a history of (i) content presentations by a plurality of publishers on a plurality of client devices and (ii) user activity associated with the content presentations on the client devices. A plurality of conversion events associated with the content presentations is identified (step 504). A touch point journey is determined (step 506) for each conversion event. The touch point journey includes a sequence of one or more of content presentations associated with the conversion event. One or more first performance indicators are calculated (step 508) for each publisher based on the touch point journeys. One or more second performance indicators are calculated (step 510) for each publisher based on the history of user activity associated with the content presentations. A score for each publisher is calculated (step 512) based on the one or more first performance indicators and the one or more second performance indicators. The score includes or provides an indication of publisher quality. Based on the calculated scores, an adjustment of content presentations by the plurality of publishers is facilitated (step 514).

In certain instances, the publisher quality assessments described herein can be performed periodically in batches, for example, on a daily basis (or other suitable time period) using recent historical data. Publishers can be scored based on deviations from a robust baseline norm, which can be, for example, an average or median of one or more recent KPI values. The baseline norm can be made robust by removing extreme outliers. For example, the extreme 5th percentile outliers (or other appropriate percentile outliers) can be removed before the baseline norm is defined.

As indicated in FIG. 2, the system 200 preferably generates KPIs using two distinct approaches. First, through graph-based KPIs, the graph module 120 can capture interactions between various publishers or groups of publishers. The graph-based KPIs can provide a holistic view of each publisher's role in the presentation of content and the ability of the publisher to reach specific users or client devices. For example, KPIs can be extracted from a directed graph using appropriate graph analysis, more specifically, from degree distribution analysis and/or from incremental effect analysis of each publisher in the graph. Degree distribution can refer to in-degree distribution (number of edges in) and/or out-degree distribution (number of edges out) of all nodes in the directed graph. The in-degree values can capture how many unique publishers are influencing the installs of a publisher under consideration. When the in-degree value of a publisher is suspiciously high (e.g., exceeds a threshold value), the publisher may be stealing installs from a large number of other publishers. Similarly, when the out-degree value of a publisher is suspiciously high (e.g., exceeds a threshold value), the publisher may be losing installs to a large number of publishers. Incremental effect analysis of each publisher can be calculated by running a hypothetical or what-if scenario to identify a portion of installs that would be lost if the publisher were removed from the attribution waterfall. Incremental effect analysis can be used to determine an influence of one publisher over one or more other publishers. In general, the graph-based KPIs can bring to light how publishers are competing against one another to win attribution. For example, heavy competition (e.g., many edges between nodes) can indicate that there is significant overlap across publishers, with multiple publishers presenting content to the same users. Such overlap can result in an inefficient use of resources and/or can increase expenses. Additionally or alternatively, the graph-based KPIs can be used to identify fraudulent publishers that steal attributions from legitimate sources. Millions of dollars can be saved by capturing such attribution fraud in a timely manner. In various examples, the graph-based KPIs can provide a measure of how influential each publisher is in achieving conversion events.

Second, through KPIs defined across various stages of content interactions, the funnel module 122 can capture a wide variety of information related to user interactions with content. Such information can include, for example, click through rates, average clicks per device, an intent of users who download and install software applications, time to engage, and engagement level of the users inside the application. These KPIs can be used to identify publishers that are able to achieve a high rate of desirable user activity (e.g., conversion events) and/or a desirable set of users.

As described herein, the scoring module 124 can assign each publisher a quality score using anomaly detection methods, such as an isolation forest algorithm, for example, for scoring a publisher in a multi-dimensional space. The parameters of the isolation forest algorithm can be tuned in an unsupervised manner as follows. First, a parameter search space can be defined for various parameters of the algorithm, such as number of trees, maximum height of the trees, and other like parameters. Second, for each parameter combination, a list of top n anomalous publishers can be found, where n can be any suitable integer, such as 50, 100, or 200. Third, a network can be constructed in which each node in the network represents a particular parameter combination, and a weight of an edge between two nodes represents a Jaccard similarity of the anomalous publisher list of the two parameter combinations. Edges that have low Jaccard similarity are preferably pruned out of the network. Next, the node having the highest degree can be used to define the robust set of parameter values for the isolation forest model.

In preferred implementations, highly anomalous publishers can receive a high first score S1; however, a high first score S1 does not necessarily mean a publisher is high or low quality. Rather, the first score S1 can be combined with a second score S2 to determine which anomalous publishers are high quality and which anomalous publishers are low quality. Such determinations can be made using domain knowledge and dynamic thresholds to identify outliers for each KPI. Domain knowledge generally refers to intuition and understanding of what high and low represent for each KPI. For example, a high click-through rate is generally good, and a high churn rate is generally bad.

Additionally or alternatively, use of dynamic baselines or thresholds can compensate for changes in publisher activity that occur over time, thereby reducing false positives. A robust, dynamic baseline or threshold can be generated by considering the most recent data (e.g., within a previous day or week) and/or by performing data-cleansing, such as, for example, outlier removal, robust metric selection, and the like. Dynamic thresholds can be calculated based on appropriate statistical percentiles, for example, to remove outliers using a 5th percentile rule, although other appropriate percentile rules are possible. In some instances, a threshold derived a month ago can be significantly different from a threshold derived using more current data.

To extract actionable insights from big data, it can be important in some examples to leverage big data technologies, so that there is sufficient support for processing large volumes of data. Examples of big data technologies that can be used with the systems and methods described herein include, but are not limited to, APACHE HIVE and APACHE SPARK. In general, APACHE HIVE is an open source data warehousing infrastructure built on top of HADOOP for providing data summarization, query, and analysis. APACHE HIVE can be used, for example, as part of the processing module 118. APACHE SPARK is, in general, an open source processing engine built around speed, ease of use, and sophisticated analytics. APACHE SPARK can be leveraged to detect abnormal deviations in a scalable and timely manner. APACHE SPARK can be used, for example, as part of the processing module 118. In general, the real-time capabilities of the systems and methods described herein can be achieved or implemented using APACHE SPARK or other suitable real-time platforms that are capable of processing large volumes of real-time data.

Advantageously, the systems and methods described herein are generally configured in a modular fashion, so that adding new anomaly detection algorithms or adding new KPIs can be done with minimal effort. This allows the anomaly detection and publisher scoring systems and methods to be refined and updated, as needed.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A computer-implemented method, comprising:
obtaining data comprising a history of (i) content presentations by a plurality of publishers on a plurality of client devices and (ii) user activity associated with the content presentations on the client devices;
identifying a plurality of conversion events associated with the content presentations;
determining a touch point journey for each conversion event, the touch point journey comprising a sequence of one or more of content presentations associated with the conversion event;
calculating one or more first performance indicators for each publisher based on the touch point journeys;
calculating one or more second performance indicators for each publisher based on the history of user activity associated with the content presentations;
calculating a score for each publisher based on the one or more first performance indicators and the one or more second performance indicators, the score comprising an indication of publisher quality; and
based on the calculated scores, facilitating an adjustment of content presentations by the plurality of publishers.

2. The method of claim 1, wherein the user activity comprises action taken by users during and after the content presentations.

3. The method of claim 2, wherein the action taken by users after the content presentations comprises installing a software application and interacting with the software application.

4. The method of claim 1, wherein at least one of the conversion events comprises action encouraged by one or more of the content presentations.

5. The method of claim 1, wherein determining the touch point journey comprises:
generating a directed graph in which nodes represent the publishers and edges represent interaction between publishers.

6. The method of claim 1, wherein the one or more first performance indicators for a publisher comprise a measure of interaction between the publisher and other publishers.

7. The method of claim 1, wherein the one or more second performance indicators for a publisher comprise a measure of user activity associated with content presented by the publisher.

8. The method of claim 1, wherein the score is calculated using an isolation forest model.

9. The method of claim 1, wherein calculating the score comprises:
calculating a first score comprising an indication of anomalous publisher performance; and
calculating a second score comprising an indication of a favorability of the anomalous publisher performance.

10. The method of claim 1, wherein facilitating the adjustment of content presentations comprises preventing a publisher from presenting content.

11. A system, comprising:
one or more computer processors programmed to perform operations comprising:
obtaining data comprising a history of (i) content presentations by a plurality of publishers on a plurality of client devices and (ii) user activity associated with the content presentations on the client devices;
identifying a plurality of conversion events associated with the content presentations;
determining a touch point journey for each conversion event, the touch point journey comprising a sequence of one or more of content presentations associated with the conversion event;
calculating one or more first performance indicators for each publisher based on the touch point journeys;
calculating one or more second performance indicators for each publisher based on the history of user activity associated with the content presentations;
calculating a score for each publisher based on the one or more first performance indicators and the one or more second performance indicators, the score comprising an indication of publisher quality; and
based on the calculated scores, facilitating an adjustment of content presentations by the plurality of publishers.

12. The system of claim 11, wherein the user activity comprises action taken by users during and after the content presentations.

13. The system of claim 11, wherein at least one of the conversion events comprises action encouraged by one or more of the content presentations.

14. The system of claim 11, wherein determining the touch point journey comprises:
generating a directed graph in which nodes represent the publishers and edges represent interaction between publishers.

15. The system of claim 11, wherein the one or more first performance indicators for a publisher comprise a measure of interaction between the publisher and other publishers.

16. The system of claim 11, wherein the one or more second performance indicators for a publisher comprise a measure of user activity associated with content presented by the publisher.

17. The system of claim 11, wherein the score is calculated using an isolation forest model.

18. The system of claim 11, wherein calculating the score comprises:
calculating a first score comprising an indication of anomalous publisher performance; and
calculating a second score comprising an indication of a favorability of the anomalous publisher performance.

19. The system of claim 11, wherein facilitating the adjustment of content presentations comprises preventing a publisher from presenting content.

20. An article, comprising:
a non-transitory computer-readable medium having instructions stored thereon that, when executed by one or more computer processors, cause the computer processors to perform operations comprising:
obtaining data comprising a history of (i) content presentations by a plurality of publishers on a plurality of client devices and (ii) user activity associated with the content presentations on the client devices;
identifying a plurality of conversion events associated with the content presentations;
determining a touch point journey for each conversion event, the touch point journey comprising a sequence of one or more of content presentations associated with the conversion event;
calculating one or more first performance indicators for each publisher based on the touch point journeys;
calculating one or more second performance indicators for each publisher based on the history of user activity associated with the content presentations;
calculating a score for each publisher based on the one or more first performance indicators and the one or more second performance indicators, the score comprising an indication of publisher quality; and
based on the calculated scores, facilitating an adjustment of content presentations by the plurality of publishers.
